(19) United States
(12) Patent Application Publication
(10) Pub. No.: US 2008/0079749 A1
(43) Pub. Date: Apr. 3, 2008

(54) WHITE BALANCE METHOD FOR IMAGE PROCESSING

(75) Inventors: Chun-Hung Lin, BanQiao City (TW); Tzu-Lan Shen, Taoyuan City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: FARADAY TECHNOLOGY CORP., Hsinchu City (TW)

(21) Appl. No.: 11/536,078

(22) Filed: Sep. 28, 2006

(51) Int. Cl. G09G 5/02

(52) U.S. Cl. 345/590

(57) ABSTRACT

A white balance method is disclosed for image processing. Characteristic information of a portion of pixels in a first frame is detected. First pixels are selected when the characteristic information of the first pixels in the first frame meets an optical requirement. An average hue of the selected first pixels is obtained. A hue range the average hue belongs to is determined. Characteristic information of a portion of the pixels in a second frame is detected. Second pixels are selected when the characteristic information of the second pixels in the second frame meets the optical requirement and a pixel hue of the second pixels is within the hue range. A first average red-channel value, a first average green-channel value, and a first average blue-channel value of the selected second pixels are obtained for acquiring a gain of each color component of an image. The gain of each color component of the image is adjusted according to the hue range.

### BACKGROUND OF THE INVENTION

1. Field of the Invention

The invention relates to a white balance method, and in particular relates to a hue and saturation based white balance method.

2. Description of the Related Art

Color temperature is a way of measuring the quality of a light source. The human visual system can quickly adjust to different color temperatures. Digital cameras usually have built-in sensors to measure the current color temperature and adopt an algorithm to process the image so that the final result may be close to what we see. The algorithm used may not always be accurate enough. In some situations when the in-camera algorithm can not set the color temperature correctly or when some creative and special effects are desired, the camera can use a particular color temperature. An adjustment that ensures the white color viewed directly will also appear in the image is referred to as white balance. Setting the white balance incorrectly may cause a color shift in the image. For example, suppose the camera is instructed to use a color temperature of sunlight to take an image of an indoor environment illuminated mainly by incandescent lights. The camera will expect excessive blue light and moderate red light, and set its algorithm to be more sensitive to the blue light. In an environment illuminated with incandescent lights, however, color temperature is low with excessive red light rather than blue. As a result, we shall see a reddish or yellowish image. Conversely, if the camera is set to a low color temperature (e.g., incandescent light) and the photo is taken under sunlight. Because the white balance is set to incandescent light, the processing algorithm is more sensitive to the red light rather than blue. Hence, the resulting image will be bluish.

Conventional algorithms devised to perform the white balance are typically based on the gray world theory. The gray world theory assumes that the average of the perceived world is gray and that any departure from this average is caused by a shift in the color of the illuminant. In other words, the average of a red-channel value, green-channel value, and blue-channel value of a scene under a given illuminant is “gray”, where gray is defined as the average of the entire reflectance. Algorithms applying the gray world theory calculate an average red-channel value, an average green-channel value, and a blue-channel value. From these average values of each color channel, ratios between each color channel and a reference color channel (green is the most common choice for the reference color channel) can be obtained. The ratios are then utilized to correct the image.

FIG. 1 illustrates a flowchart of a conventional white balance method based on the gray world theory. As shown in FIG. 1, a luminance and a saturation of a portion of pixels in a frame are detected (S11). Pixels are selected when the luminance of the pixels in the frame is over or equal to a predetermined luminance and the saturation of the pixels in the frame is under a predetermined saturation (S12). Red-channel values, green-channel values, and blue-channel values of the selected pixels are collected (S13). An average red-channel value, an average green-channel value, and an average blue-channel value of the selected pixels are then obtained from the collected red-channel values, green-channel values, and blue-channel values respectively (S15) when the selection process is complete (S14). A red-channel gain is obtained by the average red-channel value and the average green-channel value of the selected pixels, and a blue-channel gain is obtained by the average blue-channel value and the average green-channel value of the selected pixels. The red-channel gain and the blue-channel gain are then adjusted to correct the image.

Very often, however, the standard average reflectance is not equal to the actual visual field average, in which case the algorithms based on the gray world theory yield poor results. The algorithms have the tendency to shift colors towards gray. Thus, an image containing only a blue sky will become gray, because the algorithms will consider the average blue reflectance as an effect of the illuminant and will correct the scene such that the average become gray.

### BRIEF SUMMARY OF THE INVENTION

In view of the foregoing, this invention provides a white balance method for image processing. A luminance and a saturation of a portion of pixels in a first frame are detected. First pixels are selected when the luminance of the first pixels in the first frame is over or equal to a predetermined luminance and the saturation of the first pixels in the first frame is under a predetermined saturation. An average hue is obtained according to a second average red-channel value, a second average green-channel value, and a second average blue-channel value of the selected first pixels. A hue range the average hue belongs to is determined. A luminance and a saturation of a portion of pixels in a second frame are detected. Second pixels are selected when the luminance of the second pixels in the second frame is over or equal to a predetermined luminance, the saturation of the second pixels in the second frame is under a predetermined saturation, and a pixel hue of the second pixels is within the hue range. A first average red-channel value, a first average green-channel value, and a first average blue-channel value of the selected second pixels are obtained for acquiring a red-channel gain and a blue-channel gain of an image. The red-channel gain is obtained by the first average red-channel value and the first average green-channel value of the selected second pixels, and the blue-channel gain is obtained by the first average green-channel value and the first average blue-channel value of the selected second pixels.

The red-channel gain and the blue-channel gain are then adjusted according to the hue range. The red-channel gain is decreased and the blue-channel gain is increased when the hue range is a red hue range. The red-channel gain and the blue-channel gain are increased when the hue range is a green hue range. The red-channel gain is increased and the blue-channel gain is decreased when the hue range is a blue hue range. The red-channel gain and the blue-channel gain are decreased when the hue range is a purple hue range.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a flowchart of a related art;

FIG. 2 is a flowchart of an embodiment of white balance method;

FIG. 3 illustrates an embodiment of a hue-saturation-value color space; and

FIG. 4 illustrates an embodiment of a hue distribution.

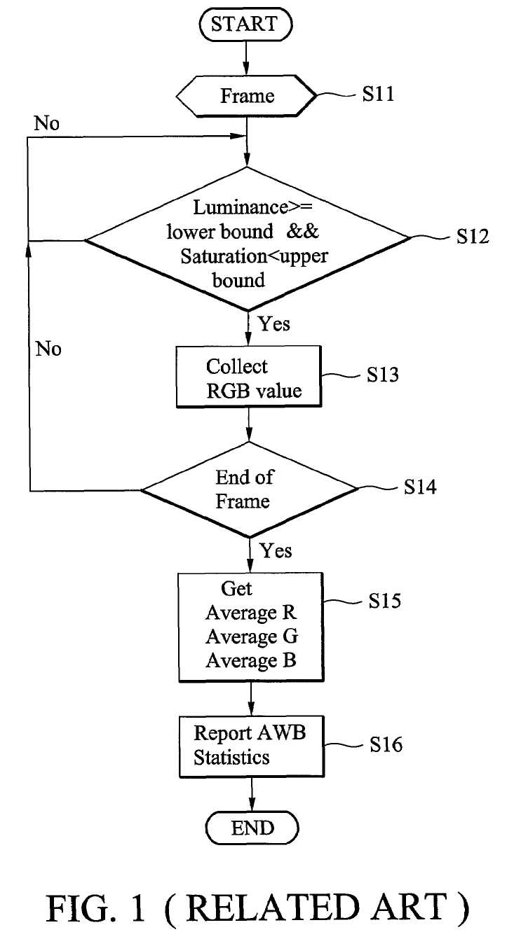

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

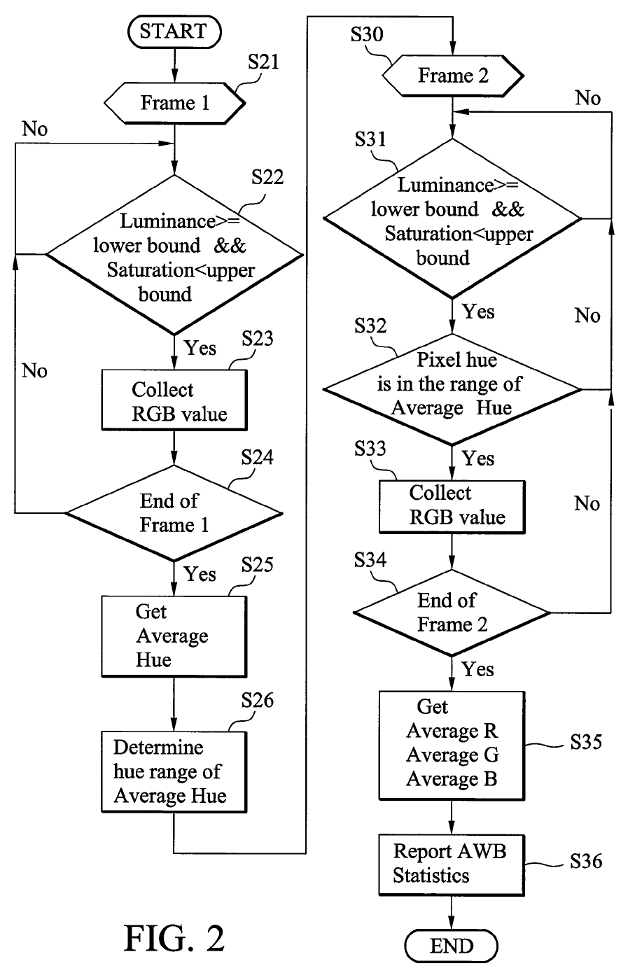

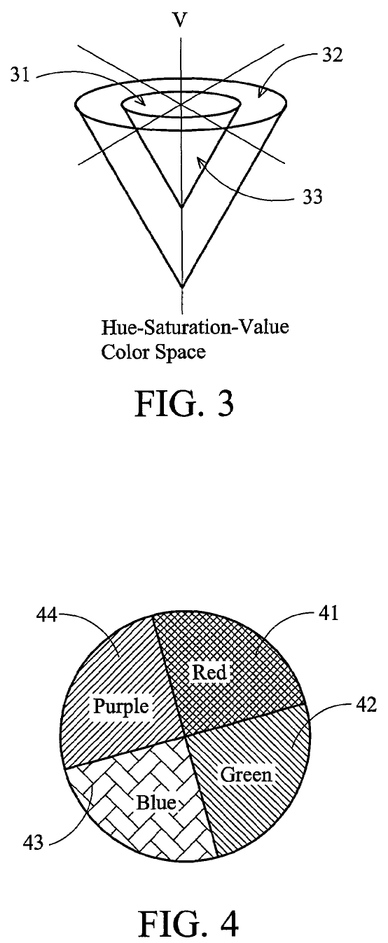

FIG. 2 illustrates a flowchart of a white balance method in accordance with an embodiment of the present invention. As shown in FIG. 2, characteristic information of pixels in a first frame is captured (S21). The characteristic information comprises a luminance and a saturation of the pixels. The luminance and the saturation of the pixels in the first frame are detected to determine whether characteristic information of the pixels in the first frame is useful or not (S22). FIG. 3 illustrates an embodiment of a hue-saturation-value color space. As shown in FIG. 3, pixels of lower saturation (31) are useful in filtering out abnormal pixels to obtain a more accurate average hue, since pixels of higher saturation (32) are not vulnerable to external color temperature. Thus, only those pixels of lower saturation are qualified (33). Referring back to FIG. 2, first pixels are selected when the luminance of the first pixels in the first frame is over or equal to a predetermined luminance and the saturation of the first pixels in the first frame under a predetermined saturation. Red-channel values, green-channel values, and blue-channel values of the selected first pixels are collected (S23). An average red-channel value, an average green-channel value, and an average blue-channel value of the selected first pixels are then obtained from the collected red-channel values, green-channel values, and blue-channel values respectively when the first selection process is complete (S24). An average hue is obtained according to the average red-channel value, the average green-channel value, and the average blue-channel value of the selected first pixels (S25). Next, a hue range the average hue belongs to is then determined (S26). FIG. 4 illustrates an embodiment of a hue distribution method. The hue distribution is distributed into four color spectra comprising a red hue range (41), a green hue range (42), a blue hue range (43), and a purple hue range (44). If the obtained average hue falls into the red hue range (41), the hue range the average hue belonging to is the red hue range (41).

Afterward, characteristic information of pixels in another frame, a second frame, is captured (S30). The characteristic information comprises a luminance, a saturation, and a pixel hue of the pixels. The luminance and the saturation of the pixels in the second frame are detected to determine whether characteristic information of the pixels in the second frame is useful. As described, FIG. 3 illustrates an embodiment of a hue-saturation-value color space. As shown in FIG. 3, pixels of lower saturation (31) are more useful in filtering out abnormal pixels to obtain a more accurate average hue, since pixels of higher saturation (32) are not vulnerable to external color temperature. Thus, only those pixels of lower saturation are qualified (33). Moreover, the hue range acquired from the first frame can be utilized to filter out pixels not within the hue range to obtain more accurate average values for each color channel. For example, if the hue range acquired from the first frame is the purple hue range (44), pixels not within the purple hue range (44) are filtered out to prevent unqualified pixels from affecting average values for each color channel. Referring to FIG. 2, second pixels are selected when the luminance of the second pixels in the second frame is over or equal to a predetermined luminance (S31), the saturation of the second pixels in the second frame is under a predetermined saturation (S31), and a pixel hue of the second pixels is within the hue range (S32).

Red-channel values, green-channel values, and blue-channel values of the selected second pixels are collected (S33). An average red-channel value, an average green-channel value, and an average blue-channel value of the selected first pixels are then obtained from the collected red-channel values, green-channel values, and blue-channel values respectively (S35) for acquiring a red-channel gain and a blue-channel gain of an image when the second selection process is complete (S34).

The red-channel gain is obtained by the average red-channel value and the average green-channel value of the selected second pixels, and the blue-channel gain is obtained by the average green-channel value and the average blue-channel value of the selected second pixels. The red-channel gain and the blue-channel gain are then adjusted according to the average hue. The red-channel gain is decreased and the blue-channel gain is increased when the hue range is the red hue range (41). The red-channel gain and the blue-channel gain are increased when the hue range is the green hue range (42). The red-channel gain is increased and the blue-channel gain is decreased when the average hue is the blue hue range (43). The red-channel gain and the blue-channel gain are decreased when the hue range is the purple hue range (44).

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A white balance method for image processing, comprising:
detecting characteristic information of a plurality of pixels in a first frame;
selecting a plurality of first pixels when the characteristic information of the first pixels in the first frame meets an optical requirement;
obtaining an average hue of the selected first pixels;
determining a hue range the average hue belongs to;
detecting characteristic information of a plurality of pixels in a second frame;
selecting a plurality of second pixels when the characteristic information of the second pixels in the second frame meets the optical requirement and a pixel hue of the second pixels is within the hue range;
obtaining a first average red-channel value, a first average green-channel value, and a first average blue-channel value of the selected second pixels for acquiring a gain of each color component of an image; and
adjusting the gain of each color component of the image according to the hue range.

2. The white balance method as claimed in claim 1, wherein the optical requirement is a luminance of the pixel over or equal to a predetermined luminance and a saturation of the pixel under a predetermined saturation.

3. The white balance method as claimed in claim 1, wherein the average hue is obtained according to a second average red-channel value, a second average green-channel value, and a second average blue-channel value of the selected first pixels.

4. The white balance method as claimed in claim 1, wherein the color component of the image comprises a red-channel and a blue-channel.

5. The white balance method as claimed in claim 1, wherein the gain of the color component of the image is adjusted by decreasing a red-channel gain and increasing a blue-channel gain when the hue range is a red hue range.

6. The white balance method as claimed in claim 5, wherein the red-channel gain is obtained by the first average red-channel value and the first average green-channel value of the selected second pixels, and the blue-channel gain is obtained by the first average green-channel value and the first average blue-channel value of the selected second pixels.

7. The white balance method as claimed in claim 1, wherein the gain of the color component of the image is adjusted by increasing a red-channel gain and a blue-channel gain when the hue range is a green hue range.

8. The white balance method as claimed in claim 7, wherein the red-channel gain is obtained by the first average red-channel value and the first average green-channel value of the selected second pixels, and the blue-channel gain is obtained by the first average green-channel value and the first average blue-channel value of the selected second pixels.

9. The white balance method as claimed in claim 1, wherein the gain of the color component of the image is adjusted by increasing a red-channel gain and decreasing a blue-channel gain when the hue range is a blue hue range.

10. The white balance method as claimed in claim 9, wherein the red-channel gain is obtained by the first average red-channel value and the first average green-channel value of the selected second pixels, and the blue-channel gain is obtained by the first average green-channel value and the first average blue-channel value of the selected second pixels.

11. The white balance method as claimed in claim 1, wherein the gain of the color component of the image is adjusted by decreasing a red-channel gain and a blue-channel gain when the hue range is a purple hue range.

12. The white balance method as claimed in claim 11, wherein the red-channel gain is obtained by the first average red-channel value and the first average green-channel value of the selected second pixels, and the blue-channel gain is obtained by the first average green-channel value and the first average blue-channel value of the selected second pixels.
